(19) United States
(12) Patent Application Publication
(10) Pub. No.: US 2010/0036764 A1
(43) Pub. Date: Feb. 11, 2010

(54) OPERATION OF INTERNET WEBSITES

(75) Inventor: Satish Mehta, Fremont, CA (US)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 12/189,472

(22) Filed: Aug. 11, 2008

(51) Int. Cl. G06Q 40/00

(52) U.S. Cl. 705/37

(57) ABSTRACT

A method and system for facilitating the operation of an Internet website is provided. The method employed by the system may include receiving, at an exchange, information about a publisher's website for which the publisher wishes to sell shares and communicating the information to an investor. The investor may then generate a purchase order for purchasing a number of shares in the publisher's website. A money amount may then be transferred from an account associated with the investor to an account associated with the publisher. At a later time, dividends may be paid to the investor or an investor may sell his shares in the website to a different investor.

### BACKGROUND

The Internet has emerged as a powerful medium for conveying information and for conducting business related to a wide variety of areas. For instance, newspaper publishers typically provide the same news stories online as they do in print. Dating services utilize the Internet to match couples. Search engines are provided for locating other websites related to search queries.

Many website publishers subsidize the costs associated with operating these websites by selling advertising space. For example, in the search engine context, advertisements may be displayed on search websites and may be targeted to individuals based upon search terms provided by the individuals. Other websites, such as news and sports websites may provide space for advertisements related to the content displayed on the web page. In other cases, website publishers subsidize costs associated with operating their respective websites by charging a fee to those that utilize the services provided by the website. For example, a job placement website may charge a fee to users searching for jobs.

The more popular a website becomes the more potential there is for generating revenue from the website. However, during inception a website may not produce sufficient revenue. For example, there may not be enough traffic to the new website to generate much interest from advertisers. In some instances, a publisher may be able to obtain a loan to operate the website. However, the publisher still bears the risk that the website will not generate sufficient revenue to pay back the loan.

### BRIEF DESCRIPTION OF THE DRAWINGS

FIG. 1 is a system for facilitating the operation of Internet websites;

FIG. 2 is a flow diagram for selling shares in a publisher web page and/or website to investors;

FIG. 3 is a flow diagram for paying dividends to shareholders;

FIG. 4 is a flow diagram for transferring shares from a shareholder to another investor; and

FIG. 5 illustrates a general computer system, which may represent any of the computing devices referenced herein.

### DETAILED DESCRIPTION OF THE DRAWINGS AND THE PRESENTLY PREFERRED EMBODIMENTS

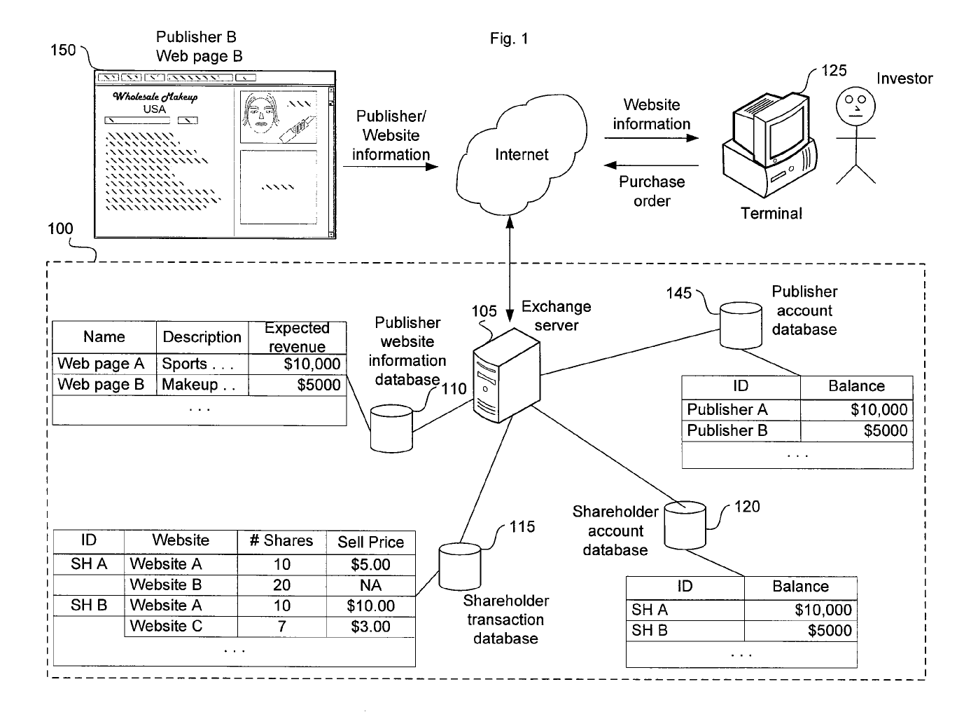

FIG. 1 is a system 100 for facilitating the operation of Internet websites. The system 100 includes an exchange server 105, a publisher website information database 110, a shareholder transaction database 115, a shareholder account database 120, and a publisher account database 145. Also shown in FIG. 1 are an exemplary publisher webpage 150 and a terminal 125 that communicates with the system.

The exchange server 105 may include suitable logic, code, and/or circuitry that may enable performing investment related transactions between other investors and web page and/or website publishers and between investors. In one embodiment, the exchange server 105 enables publishers to sell shares in a website 150 to investors, so that the publishers may generate starting capital. In another embodiment, shareholders sell their respective shares to other investors. Publishers and investors may conduct the transactions described above via a network in communication with the system 100, such as an Internet connection.

The exchange server 105 may be implemented using any conventional computer or other data processing device. For example, the exchange server 105 may correspond to an Intel® based computer running applications such as Apache® or Microsoft Internet Information Server®, which may be utilized to generate web pages that may be necessary to facilitate the transactions described above. The exchange server 105 may further be adapted to store and retrieve information communicated over the network to various databases, such as the publisher website information database 110, the shareholder transaction database 115, the shareholder account database 120, and the publisher account database 145.

The publisher website information database 110, shareholder transaction database 115, shareholder account database 120, and publisher account database 145 correspond to storage elements for storing various types of information associated with the operation of the exchange server 105. The databases may reside within the exchange server 105 itself or may reside within other networked computers. Although represented as separate databases in FIG. 1, the publisher website information database 110, shareholder transaction database 115, shareholder account database 120, and publisher account database 145 may reside within a single storage element. Also, a unified database with tables corresponding to the separate databases may be utilized.

The publisher website information database 110 may store information related to websites for which shares may be purchased. The publisher website information database 110 may include one or more fields for the name of a publisher, the name of the publisher website, a description of the website, and an expected amount of revenue generated from the website. Other fields may be included as well, or may be substituted for the fields listed here.

The description field may specify the type of content conveyed via the web pages operating on the website and also information describing a target audience. For example, demographic and/or geographic information related to an audience may be specified. In addition, the total number of shares available for purchase along with the dividends associated with the shares may be specified. Shareholder rights may also be specified. Shareholder rights correspond to the rights that an owner of a share in a website has in the website. For example, the shareholder rights may specify that a shareholder has no rights in deciding the content of the web pages operating on the website. As another example, the shareholder rights may specify that shareholders vote for the type of content conveyed by the web pages.

The shareholder transaction database 115 may store information for keeping track of the number of shares in a publisher website that a shareholder owns. The shareholder transaction database 115 may include fields for identifying the shareholder and website for which shares are held. The number of shares is also stored. In addition, a selling price field may be provided. The selling price field corresponds to a price at which a particular shareholder is willing to sell his shares.

The shareholder account database 120 may store information related to a money account associated with the various shareholders that purchased shares in websites via the system 100. In certain embodiments, the shareholder account database 120 may include a money amount corresponding to an amount of money a shareholder has available for performing transactions via the system 100. In other embodiments, the shareholder account database 120 may include a link to an account that may be utilized to facilitate the transactions. For example, a link to a bank account may be provided. Funds may be added or removed from the account. For example, when a shareholder sells share, a corresponding price per share may be added to his account. Conversely, when an investor purchases shares, a money amount may be deducted.

The publisher account database 145 may store information related to a money account associated with the various publishers utilizing the system 100 to sell shares in websites. In certain embodiments, the publisher account database 145 may include a money amount corresponding to an amount of money a publisher has received for selling shares in websites. In other embodiments, the publisher account database 145 may include a link to an account that may be utilized to receive the funds. Funds may be added or removed from an account associated with a publisher depending on the type of transaction being performed by the publisher.

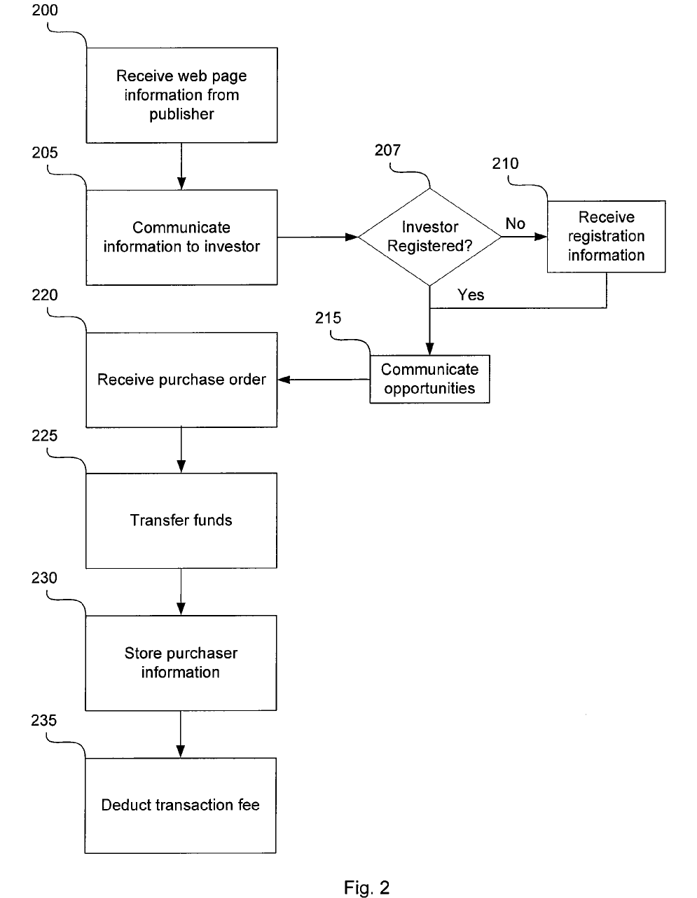

The operation of the system 100 will now be described with reference to FIGS. 2-4 below. FIG. 2 is a flow diagram for selling shares in a publisher web page and/or website to investors. At block 200, information that enables a publisher to sell shares in websites may be received. For example, a publisher registration web page (not shown) hosted on the exchange server 105 may be communicated to a publisher. The publisher registration web page may enable the publisher to specify information related to the website 150. The information specified may include the publisher's name, a name of the website, a description of the website, and an expected amount of revenue to be generated from the website. The description may specify the type of content conveyed via the website, audience targeting information, the total number of shares available for purchase, the dividends associated with the shares, and shareholder rights.

After registration, the information specified by the publisher along with publisher identifying information is stored to the publisher website information database 110. During registration, the publisher may also specify information that may be utilized to generate an account for the publisher in the publisher account database 145. For example, the publisher may specify a bank account for transferring funds associated with the shares.

At block 205, information related to the websites registered at block 200 are communicated to an investor. For example, a share purchase web page (not shown) hosted on the exchange server 105 may be communicated to an investor via the terminal 125.

At block 207, if this is the first time the investor has utilized the system 100, then at block 210, investor registration information may be received. For example, an investor registration web page (not shown) may be provided for specifying the investor information needed to conduct the transactions above, such as purchasing and selling shares and transferring funds. The information may include the investor's name and address. An account for adding and withdrawing funds, such as a bank account or credit card account may also be provided. The information received may be utilized to generate an account for the investor in the shareholder account database 120.

At block 215, investment opportunities are communicated to the registered investors. For example, an opportunity web page (not shown) may be provided via the terminal 125 that enables the investor to search through the publisher website information database 110 for investment opportunities in websites previously registered by a publisher. The opportunity web page may include various controls that enable controlling the scope of the search. For example, a control may be provided for limiting the search to websites with shares available for purchase within a certain price range. Other controls may be provide to restrict the search to those websites that fit a desired description and also to restrict the search to those web pages that are expected to produce a particular revenue.

At block 220, a purchase order may be received from the investor. For example, a purchase order web page (not shown) may be provided that enables the investor to select the websites he wishes to purchases shares in. The purchase order web page may include fields for specifying the name of the websites and a number of shares to purchase.

At block 225, funds are transferred from the account associated with the investor to the publisher accounts associated with the websites. The system may verify that the investor has the necessary funds in his shareholder account by checking the shareholder account database 120. Provided the funds exist, the funds are transferred from the shareholder account database 120 to the publisher account database 145. At block 230 an entry is added to the shareholder transaction database 115 indicating the number of shares purchased by the investor.

At block 235, a fee associated with the transaction above may be transferred from either or both the shareholder account database 120 and the publisher account database 145 to an account associated with the operator of the system 100. This fee may be utilized to subsidize the operation of the system 100.

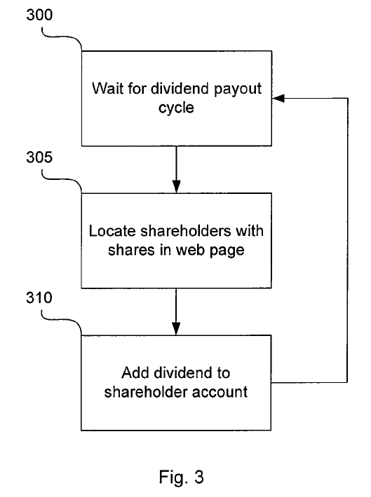

FIG. 3 is a flow diagram for paying dividends to shareholders. The blocks shown in FIG. 3 may be carried out after investors have registered and purchased shares in a publisher website. At block 300, the system may wait until the next time period for paying out dividends. The time period may correspond to a time period specified by a publisher during the registration of the website. For example, the publisher may have specified dividends to be paid on a quarterly or monthly basis.

At block 305, shareholders holding shares in a given website may be located. For example, the system 100 may search through the shareholder transaction database 115 for shareholders that own shares in the websites of the publisher.

After locating shareholders holding shares, at block 310, a money amount corresponding to the dividend specified by the publisher may be transferred from the account associated with the publisher to the shareholder account associated with the located shareholders. The dividend amount may correspond to the dividend specified in the publisher website information database 110 stored during the publisher registration process. The dividend amount may be specified in terms of an absolute money amount or a percentage of the revenue generated by the website. For example, the publisher may have specified a dividend of $1.00 per share or may have specified a dividend amount of 1% of revenue per share. As noted above, the system 100 may require the publisher to periodically specify the revenue being generated by a given website.

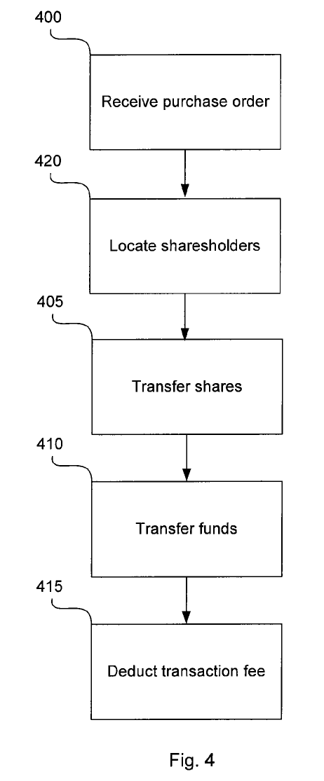

FIG. 4 is a flow diagram for transferring shares from a shareholder to another investor. A shareholder may desire to sell his respective shares in a website for various reasons. One reason may be that the intrinsic value of the shares in a given website may have increased relative to the original purchase price. This may occur, for example, where the dividend payout associated with a website has increased over time.

To facilitate transferring shares, a share transfer web page (not shown) may be generated by the exchange server 105 and communicated to an investor via the terminal 125. The investor may have registered previously with the system, as described above with reference to FIG. 2. The share transfer web page may include various controls that enable controlling the scope of the search. For example, a control may be provided for limiting the search to websites with shares available for purchase within a certain price range. Other controls may be provided to restrict the search to those websites that fit a desired description and/or restrict the search to those websites that are expected to produce a particular revenue. In addition to these controls, fields may be provided for specifying a quantity of shares desired along with a desired purchase price.

At block 420, shareholders with shares that meet the restrictions above, may be located. For example, the exchange server 105 may search through the shareholder transaction database 115 for shareholders selling shares at the price range specified above. A shareholder may have specified a selling price for the shares at an earlier time. For example, the shareholder may have specified an absolute value at which to sell the shares. Alternatively, the shareholder may have specified that the shares be sold based on the price that other shareholders are selling their respective shares. For example, the shareholder may desire to sell his shares for a price corresponding to the maximum price, minimum price, or average price of the shares currently being offered for sale by other shareholders.

The exchange server 105 may search through the shareholder transaction database 115 for available shares so as to satisfy the investor's order. For example, the exchange server 105 may begin by selecting those shares offered for sale at the lowest selling price and then work up from there until the desired number of shares is reached. In some instances, the average purchase cost may be lower than the amount specified by the investor. The savings may be passed on to the purchaser, the owner of the system 100 or to the publisher. Where the order cannot be satisfied at the desired purchase price, the system may obtain the maximum number of shares available and notify the investor of the number of shares acquired at the investors proposed purchase price.

At block 410, funds may be transferred from the account associated with the investor to the respective shareholder accounts. The shareholder account database 120 is then updated accordingly. The shareholder transaction database 115 is also updated to reflect the transfer of shares from the original owners to the investor.

At block 415, a fee associated with the transaction above may be transferred from either or both the shareholder account associated with the investor, or the shareholder accounts associated with those shareholders that sold shares to the investor, to an account associated with the operator of the system 100. This fee may be utilized to subsidize the operation of the system 100

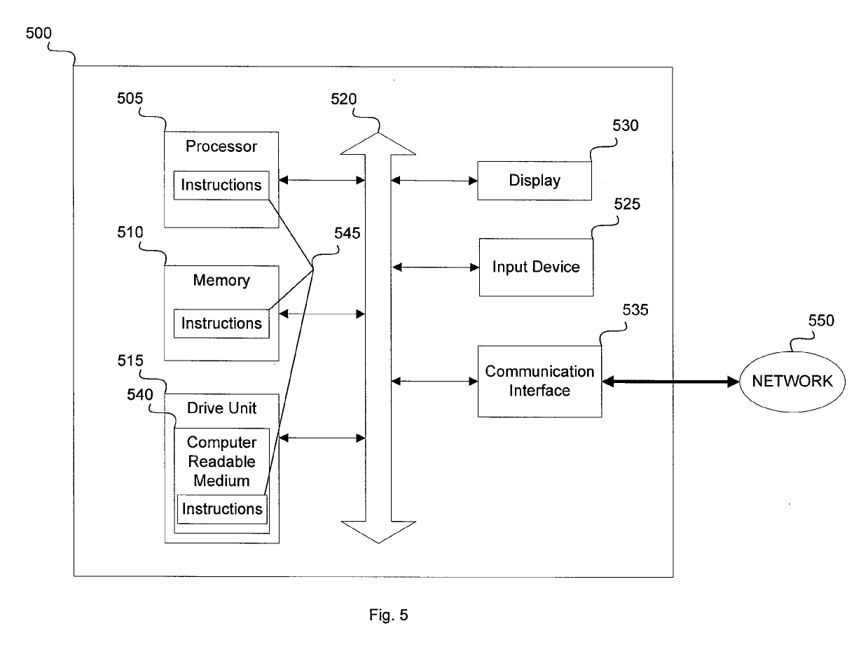

FIG. 5 illustrates a general computer system, which may represent the exchange server 105 in FIG. 1 or any of the other computing devices referenced herein. The computer system 500 may include a set of instructions 545 that may be executed to cause the computer system 500 to perform any one or more of the methods or computer based functions disclosed herein. The computer system 500 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 500 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions 545 (sequential or otherwise) that specify actions to be taken by that machine. In one embodiment, the computer system 500 may be implemented using electronic devices that provide voice, video or data communication. Further, while a single computer system 500 may be illustrated, the term “system” shall also be taken to include any collection of systems or sub-systems that individually or jointly execute a set, or multiple sets, of instructions to perform one or more computer functions.

As illustrated in FIG. 5, the computer system 500 may include a processor 505, such as, a central processing unit (CPU), a graphics processing unit (GPU), or both. The processor 505 may be a component in a variety of systems. For example, the processor 505 may be part of a standard personal computer or a workstation. The processor 505 may be one or more general processors, digital signal processors, application specific integrated circuits, field programmable gate arrays, servers, networks, digital circuits, analog circuits, combinations thereof, or other now known or later developed devices for analyzing and processing data. The processor 505 may implement a software program, such as code generated manually (i.e., programmed).

The computer system 500 may include a memory 510 that can communicate via a bus 520. For example, the publisher website information database 110, the shareholder transaction database 115, the shareholder account database 120, and the publisher account database 145 may be stored in the memory. The memory 510 may be a main memory, a static memory, or a dynamic memory. The memory 510 may include, but may not be limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one case, the memory 510 may include a cache or random access memory for the processor 505. Alternatively or in addition, the memory 510 may be separate from the processor 505, such as a cache memory of a processor, the system memory, or other memory. The memory 510 may be an external storage device or database for storing data. Examples may include a hard drive, compact disc (“CD”), digital video disc (“DVD”), memory card, memory stick, floppy disc, universal serial bus (“USB”) memory device, or any other device operative to store data. The memory 510 may be operable to store instructions 545 executable by the processor 505. The functions, acts or tasks illustrated in the figures or described herein may be performed by the programmed processor 505 executing the instructions 545 stored in the memory 510. The functions, acts or tasks may be independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

The computer system 500 may further include a display 530, such as a liquid crystal display (LCD), an organic light emitting diode (OLED), a flat panel display, a solid state display, a cathode ray tube (CRT), a projector, a printer or other now known or later developed display device for outputting determined information. The display 530 may act as an interface for the user to see the functioning of the processor 505, or specifically as an interface with the software stored in the memory 510 or in the drive unit 515.

Additionally, the computer system 500 may include an input device 525 configured to allow a user to interact with any of the components of system 500. The input device 525 may be a number pad, a keyboard, or a cursor control device, such as a mouse, or a joystick, touch screen display, remote control or any other device operative to interact with the system 500.

The computer system 500 may also include a disk or optical drive unit 515. The disk drive unit 515 may include a computer-readable medium 540 in which one or more sets of instructions 545, e.g. software, can be embedded. Further, the instructions 545 may perform one or more of the methods or logic as described herein. The instructions 545 may reside completely, or at least partially, within the memory 510 and/or within the processor 505 during execution by the computer system 500. The memory 510 and the processor 505 also may include computer-readable media as discussed above.

The present disclosure contemplates a computer-readable medium 540 that includes instructions 545 or receives and executes instructions 545 responsive to a propagated signal; so that a device connected to a network 550 may communicate voice, video, audio, images or any other data over the network 550. The instructions 545 may be implemented with hardware, software and/or firmware, or any combination thereof. Further, the instructions 545 may be transmitted or received over the network 550 via a communication interface 535. The communication interface 535 may be a part of the processor 505 or may be a separate component. The communication interface 535 may be created in software or may be a physical connection in hardware. The communication interface 535 may be configured to connect with a network 550, external media, the display 530, or any other components in system 500, or combinations thereof. The connection with the network 550 may be a physical connection, such as a wired Ethernet connection or may be established wirelessly as discussed below. Likewise, the additional connections with other components of the system 500 may be physical connections or may be established wirelessly.

The network 550 may include wired networks, wireless networks, or combinations thereof. Information related to business organizations may be provided via the network 550. The wireless network may be a cellular telephone network, an 502.11, 502.16, 502.20, or WiMax network. Further, the network 550 may be a public network, such as the Internet, a private network, such as an intranet, or combinations thereof, and may utilize a variety of networking protocols now available or later developed including, but not limited to TCP/IP based networking protocols.

The computer-readable medium 540 may be a single medium, or the computer-readable medium 540 may be a single medium or multiple media, such as a centralized or distributed database, and/or associated caches and servers that store one or more sets of instructions. The term “computer-readable medium” may also include any medium that may be capable of storing, encoding or carrying a set of instructions for execution by a processor or that may cause a computer system to perform any one or more of the methods or operations disclosed herein.

The computer-readable medium 540 may include a solid-state memory such as a memory card or other package that houses one or more non-volatile read-only memories. The computer-readable medium 540 also may be a random access memory or other volatile re-writable memory. Additionally, the computer-readable medium 540 may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that may be a tangible storage medium. Accordingly, the disclosure may be considered to include any one or more of a computer-readable medium or a distribution medium and other equivalents and successor media, in which data or instructions may be stored.

Alternatively or in addition, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system may encompass software, firmware, and hardware implementations.

Accordingly, the method and system may be realized in hardware, software, or a combination of hardware and software. The method and system may be realized in a centralized fashion in at least one computer system or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The method and system may also be embedded in a computer program product, which included all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

From the foregoing, it may be seen that the embodiments disclosed herein provide an approach for facilitating the operation of Internet websites. Publishers desiring to generate start-up capital to operate a website may register the website so as to sell shares in the website to investors. At least one incentive for the investors is that they may receive dividends. In addition, investors may sell their respective shares to other investors when the intrinsic value of the shares increases, so as to profit from purchasing the shares in the first place.

While the method and system has been described with reference to certain embodiments, it will be understood by those skilled in the art that various changes may be made and equivalents may be substituted without departing from the scope. In addition, many modifications may be made to adapt a particular situation or material to the teachings without departing from its scope. Therefore, it is intended that the present method and system not be limited to the particular embodiment disclosed, but that the method and system include all embodiments falling within the scope of the appended claims.

We claim:

1. A method for facilitating the operation of an Internet website, the method comprising:
receiving, a purchase order for purchasing shares in a website, the purchase order including a number of shares, a proposed price per share, and investor identifying information associated with a purchaser;
locating shareholders in a shareholder database associated with the website offering to sell shares at the proposed price per share;
transferring, within the shareholder database, shares from located shareholders to the investor;
deducting from an investor account a money amount corresponding to the product of the number of shares and the proposed price per share; and
adding, to shareholder accounts, a money amount corresponding to the product of a number of shares transferred from each located shareholder and the proposed price per share.

2. The method according to claim 1, wherein the shareholder database includes a selling price per share associated with each shareholder.

3. The method according to claim 1, further comprising deducting a transaction fee from at least one of: the investor account and shareholder accounts associated with each located shareholder.

4. A method for facilitating the operation of an Internet website, the method comprising:
receiving, at an exchange, information about a website, at least some of which enables an investor to determine whether to purchase shares in the website;
communicating the at least some of the information to the investor;
receiving a purchase order, the purchase order including a number of shares requested and investor identifying information for identifying the investor;
deducting from a shareholder account associated with the investor a money amount associated with purchasing the number of shares; and
adding to the money account associated with the website a money amount corresponding to the money amount deducted from the shareholder account;

5. The method according to claim 4, wherein the information includes at least one of: a description of the website, a number of shares available in the website, an initial price per share, a dividend amount per share, and a money account associated with the web page.

6. The method according to claim 4, further comprising:
storing, to a shareholder database associated with the website, the investor identifying information and a number of shares purchased by the investor.

7. The method according to claim 6, further comprising:
locating shareholders holding shares in the website by searching through the shareholder database; and
adding to the shareholder account associated with each located shareholder a money amount corresponding to the product of the dividend amount per share and the number of shares the shareholder is holding.

8. The method according to claim 4, wherein the description of the website includes an estimated revenue generated by the website.

9. The method according to claim 8, wherein the dividend amount per share is expressed in terms of a percentage of the estimated revenue generate by the website so that the money amount associated with the dividend amount increases as the estimated revenue increases.

10. The method according to claim 4, wherein an intrinsic value of a share is related to the money amount associated with the dividend.

11. The method according to claim 4, further comprising deducting a transaction fee from at least one of: the money account associated with the website, and the shareholder account.

12. A machine-readable storage medium having stored thereon, a computer program comprising at least one code section for facilitating the operation of an Internet website, the at least one code section being executable by a machine for causing the machine to perform acts of:
receiving information about a website, at least some of which enables an investor to determine whether to purchase shares in the website;
communicating the at least some of the information to the investor;
receiving a purchase order, the purchase order including a number of shares requested and investor identifying information for identifying the investor;
deducting from a shareholder account associated with the investor a money amount associated with purchasing the number of shares; and
adding to the money account associated with the website a money amount corresponding to the money amount deducted from the shareholder account;

13. The machine-readable storage medium according to claim 12, wherein the information includes at least one of: a description of the website, a number of shares available in the website, an initial price per share, a dividend amount per share, and a money account associated with the web page.

14. The machine-readable storage medium according to claim 12, wherein the at least one code section comprises code that enables:
storing, to a shareholder database associated with the website, the investor identifying information and a number of shares purchased by the investor.

15. The machine-readable storage medium according to claim 14, wherein the at least one code section comprises code that enables:
locating shareholders holding shares in the website by searching through the shareholder database; and
adding to the shareholder account associated with each located shareholder a money amount corresponding to the product of the dividend amount per share and the number of shares the shareholder is holding.

16. The machine-readable storage medium according to claim 12, wherein the description of the website includes an estimated revenue generated by the website.

17. The machine-readable storage medium according to claim 16, wherein the dividend amount per share is expressed in terms of a percentage of the estimated revenue generate by the website so that the money amount associated with the dividend amount increases as the estimated revenue increases.

18. The machine-readable storage medium according to claim 12, wherein an intrinsic value of a share is related to the money amount associated with the dividend.

19. The machine-readable storage medium according to claim 12, wherein the at least one code section comprises code that enables deducting a transaction fee from at least one of: the money account associated with the website, and the shareholder account.

20. A system for facilitating the operation of an Internet website comprising:
a server with network circuitry operable to receive information about a website, at least some of which enables an investor to determine whether to purchase shares in the website; communicate the at least some of the information to the investor; receive a purchase order, the purchase order including a number of shares requested and investor identifying information for identifying the investor; and
circuitry operable to deduct from a shareholder account associated with the investor a money amount associated with purchasing the number of shares and add to the money account associated with the website a money amount corresponding to the money amount deducted from the shareholder account;

21. The system according to claim 20, wherein the information includes at least one of: a description of the website, a number of shares available in the website, an initial price per share, a dividend amount per share, and a money account associated with the web page.

22. The system according to claim 20, further comprising circuitry operable to store to a shareholder database associated with the website, the investor identifying information and a number of shares purchased by the investor.

23. The method according to claim 22, further comprising circuitry operable to locate shareholders holding shares in the website by searching through the shareholder database; and
adding to the shareholder account associated with each located shareholder a money amount corresponding to the product of the dividend amount per share and the number of shares the shareholder is holding.

24. The system according to claim 20, wherein the description of the website includes an estimated revenue generated by the website.

25. A web site method comprising:
operating a website, including:
providing information to searchers accessing the website, wherein at least some of the information is provided on behalf of advertisers;
receiving a money value from advertisers; and
selling to shareholders a proportional part of the received monetary value based on proportional rights in the website of the shareholders.
